(19) United States
(12) Patent Application Publication
(10) Pub. No.: US 2026/0113253 A1
(43) Pub. Date: Apr. 23, 2026

(54) APPARATUS AND METHOD FOR YANG DATA MODELING OF PERFORMANCE MANAGEMENT STREAMING IN COMMUNICATION SYSTEM

(71) Applicant: ELECTRONICS AND TELECOMMUNICATIONS RESEARCH INSTITUTE, Daejeon (KR)

(72) Inventor: Bin Yeong YOON, Daejeon (KR)

(73) Assignee: ELECTRONICS AND TELECOMMUNICATIONS RESEARCH INSTITUTE, Daejeon (KR)

(21) Appl. No.: 19/360,658

(22) Filed: Oct. 16, 2025

(30) Foreign Application Priority Data
Oct. 18, 2024 (KR) 10-2024-0143463
Sep. 10, 2025 (KR) 10-2025-0128963

(51) Int. Cl. H04L 41/5003

(52) U.S. Cl. CPC H04L 41/5003

(57) ABSTRACT

The present disclosure relates generally to communication systems, and more specifically to an apparatus and method for YANG data modeling of performance management streaming in communication systems. A server device includes a transceiver and a processor operatively connected to the transceiver. The processor generates a YANG data model defining measurement methods for performance management parameters, performs count measurement that tracks cumulative occurrence counts, snapshot measurement that captures instantaneous values at specific points in time, and tidemark measurement that records maximum and minimum values during set periods, receives subscription requests for performance management data based on the YANG data model from clients, measures performance management data according to the subscription requests, and transmits the measured performance management data to clients in a streaming manner.

### CROSS REFERENCE TO RELATED APPLICATION

This application claims priority to Korean Patent Application No. 10-2024-0143463, filed on Oct. 18, 2024, and Korean Patent Application No. 10-2025-0128963, filed on Sep. 10, 2025, the entire contents of which are hereby incorporated by reference.

### BACKGROUND

### Technical Field

The present disclosure relates generally to communication systems, and more specifically to an apparatus and method for YANG data modeling of performance management streaming in communication systems.

### Description of the Related Art

Recently, as network environments become more complex and artificial intelligence technology advances, the importance of streaming telemetry technology for real-time analysis and prediction of network status is increasing. Streaming telemetry is a technology that collects and delivers network performance management data in real time, and is a core technology necessary for analyzing, inferring, and predicting network status in applications such as network digital twins.

Conventional network performance management primarily used a pull method to collect data at regular intervals. In this method, network administrators periodically connect to network equipment to request and collect performance data. However, this method has limitations in real-time network monitoring and analysis, so streaming telemetry methods where network equipment directly pushes data are being proposed as alternatives.

Streaming telemetry is a method where network equipment actively delivers performance data to collectors or analysis systems, which can significantly improve real-time performance and efficiency compared to conventional methods. In particular, real-time data with short cycles is essential in cutting-edge applications such as artificial intelligence-based network analysis or network digital twins.

However, existing technologies have the problem of lacking specific models for measurement methods and collection approaches for performance data to be delivered through streaming telemetry. In particular, systematic data modeling for how to measure performance management parameters and in what way to collect them is not clearly defined, making it difficult to ensure interoperability between network equipment.

Additionally, various measurement methods used in network performance management, such as cumulative count methods, instantaneous value measurement methods, and extreme value recording methods, are implemented individually, and there is a lack of standardized data structures that can integrally manage and stream these methods.

### SUMMARY

Recently, as network environments become more complex and artificial intelligence technology advances, the importance of streaming telemetry technology for real-time analysis and prediction of network status is increasing. Streaming telemetry is a technology that collects and delivers network performance management data in real time, and is a core technology necessary for analyzing, inferring, and predicting network status in applications such as network digital twins.

Conventional network performance management primarily used a pull method to collect data at regular intervals. In this method, network administrators periodically connect to network equipment to request and collect performance data. However, this method has limitations in real-time network monitoring and analysis, so streaming telemetry methods where network equipment directly pushes data are being proposed as alternatives.

Streaming telemetry is a method where network equipment actively delivers performance data to collectors or analysis systems, which can significantly improve real-time performance and efficiency compared to conventional methods. In particular, real-time data with short cycles is essential in cutting-edge applications such as artificial intelligence-based network analysis or network digital twins.

However, existing technologies have the problem of lacking specific models for measurement t methods and collection approaches for performance data to be delivered through streaming telemetry. In particular, systematic data modeling for how to measure performance management parameters and in what way to collect them is not clearly defined, making it difficult to ensure interoperability between network equipment.

Additionally, various measurement methods used in network performance management, such as cumulative count methods, instantaneous value measurement methods, and extreme value recording methods, are implemented individually, and there is a lack of standardized data structures that can integrally manage and stream these methods.

According to various exemplary embodiments of the present disclosure, an operation method for providing packet header handling information in a 5G system in a wireless communication system includes a process where a user plane function (UPF) having a packet header handling function registers a packet header handling feature (PHHL) in a network repository function (NRF) through a service based interface (SBI) and a process where a network function (NF) searches for the UPF containing the packet header handling Feature (PHHL) in the NRF through the SBI.

According to various exemplary embodiments of the present disclosure, an operation method for providing packet header handling information in a wireless communication system includes a process where a session management function (SMF) receives packet header handling information directly or via a network exposure function (NEF) from an application function (AF) through a policy control function (PCF) via a service based interface (SBI), a process where the SMF retransmits to a UPF the packet header handling information received from the PCF through an N4 interface, a process where the SMF receives the packet header handling information set through the N4 interface from the UPF and transmits the same directly or via the NEF to the AF through the PCF via the SBI, and a process where the UPF transmits the packet header handling information directly or via the NEF to the AF through the SBI.

According to various exemplary embodiments of the present disclosure, an apparatus for providing packet header handling information in a 5G system in a wireless communication system includes a communicator, and a controller operably connected to the communicator, wherein the controller allows a user plane function (UPF) having a packet header handling function to register a packet header handling feature (PHHL) in a network repository function (NRF) through a service based interface (SBI), and a network function (NF) to search for the UPF containing the packet header handling feature (PHHL) in the NRF through the SBI.

According to various exemplary embodiments of the present disclosure, an apparatus for providing packet header handling information in a wireless communication system includes a communicator and a controller operably connected to the communicator, wherein the controller allows a session management function (SMF) to receive packet header handling information directly or via a network exposure function (NEF) from an application function (AF) through a policy control function (PCF) via a service based interface (SBI), the SMF to retransmit the packet header handling information received from the PCF to a UPF through an N4 interface, the SMF to receive the packet header handling information set through the N4 interface from the UPF and transmits the same directly or via the NEF to the AF through the PCF via the SBI, and the UPF to transmit the packet header handling information directly or via the NEF to the AF through the SBI.

An apparatus and method according to various exemplary embodiments of the present disclosure can provide a network slicing policy, which is optimized and effective for application services, and a user-specific service, by providing packet header handling information to networks.

The effects obtained from the present disclosure are not limited to the effects mentioned above, and other effects not mentioned will be clearly understood by those skilled in the art to which the present disclosure pertains from the description below.

### BRIEF DESCRIPTION OF THE DRAWINGS

FIG. 1 is a diagram comparing SNMP-based pull methods with the streaming telemetry-based push method of the present disclosure according to various embodiments of the present disclosure.

FIG. 2 is a diagram showing the overall configuration of a streaming telemetry system according to an embodiment of the present disclosure.

FIG. 3 is a diagram showing the YANG data model structure inside a server and data flow with clients according to an embodiment of the present disclosure.

FIG. 4 shows a flowchart illustrating an operating method of a server according to an embodiment of the present disclosure.

FIG. 5 shows a flowchart illustrating an operating method of a client according to an embodiment of the present disclosure.

FIG. 6 shows a device configuration diagram according to an embodiment of the present disclosure.

### DETAILED DESCRIPTION OF THE DISCLOSURE

The terms used in the present disclosure may be used only to describe specific exemplary embodiments and may not be intended to limit the scope of other exemplary embodiments. Singular expressions may include plural expressions unless the context clearly indicates otherwise. Terms used herein, including technical or scientific terms, may have the same meaning as those generally understood by those of ordinary skill in the art described in the present disclosure. Among the terms used in the present disclosure, terms defined in a general dictionary may be interpreted in the same or similar meaning as the context of the related technology and may not be interpreted in an ideal or excessively formal meaning unless explicitly defined in the present disclosure. In some cases, even the terms defined in the present disclosure cannot be interpreted to exclude exemplary embodiments of the present disclosure.

In various exemplary embodiments of the present disclosure described below, a hardware approach will be described as an example. However, various exemplary embodiments of the present disclosure may include a technology using both hardware and software, so various exemplary embodiments of the present disclosure may not exclude a software-based approach.

In addition, in the detailed description and claim of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

The present disclosure relates to an apparatus and method for YANG data modeling of performance management streaming in communication systems. Specifically, the present disclosure describes technology for systematically defining various measurement methods for performance management parameters in communication systems and delivering them to clients through real-time streaming.

As used in the following description, terms referring to signals, terms referring to channels, terms referring to control information, terms referring to network entities, terms referring to components of the apparatus, and the like may be exemplified for convenience of description. Accordingly, the present disclosure may not be limited to terms described below, and other terms having equivalent technical meanings may be used.

In addition, the present disclosure may describe various exemplary embodiments by using terms used in some communication standards (e.g., 3GPP (3rd Generation Partnership Project)), but this is for illustrative purposes only. Various exemplary embodiments of the present disclosure can be easily modified and applied in other communication systems.

In the present disclosure, streaming telemetry refers to a protocol that collects and delivers network performance management data necessary for network status analysis, inference, and prediction in real time using artificial intelligence technology. BUT (Begin Unavailable Time) is an event indicating when a network element or connection becomes unavailable, and EUT (End Unavailable Time) is an event indicating when an unavailable state ends. CSES (Consecutive Severely Errored Seconds) refers to a sequence of severely errored seconds consecutively detected within a specified time interval. Uniform time refers to predetermined consistent points in time for taking snapshots simultaneously across all network elements, enabling correlation analysis of the entire network.

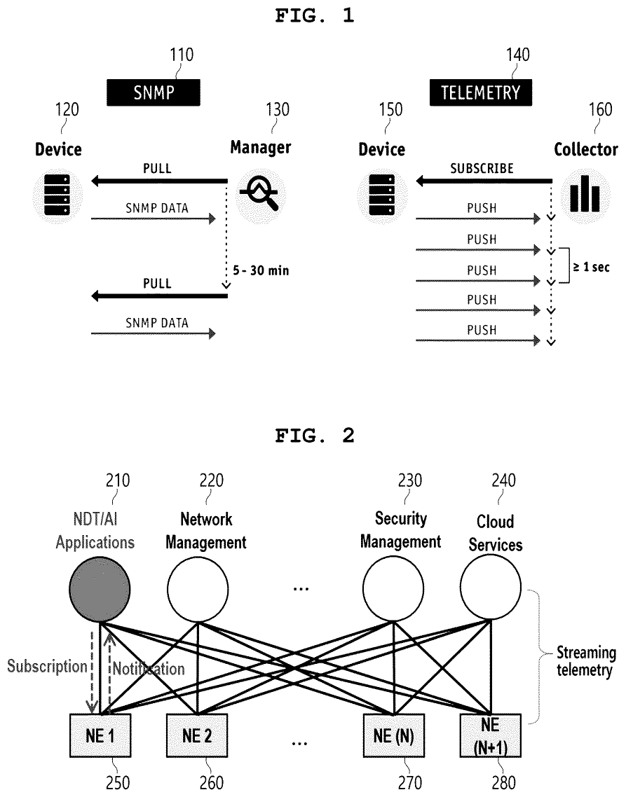

FIG. 1 is a diagram comparing SNMP-based pull methods with the streaming telemetry-based push method of the present disclosure according to various embodiments of the present disclosure.

Referring to FIG. 1, a comparison is shown between conventional SNMP (110) based performance data collection methods and the streaming telemetry (140) based performance data collection method of the present disclosure.

In the conventional SNMP (110) method, data is collected between network equipment (120) and administrators (130) using a pull method. The administrator (130) periodically requests SNMP data from network equipment (120), and the network equipment (120) responds by transmitting performance data. This method has limitations for real-time monitoring because it generally collects data at long intervals of 5 to 30 minutes. Additionally, since the administrator (130) must actively request data, network traffic increases and immediate response to urgent network situations becomes difficult.

In contrast, the streaming telemetry (140) method of the present disclosure transmits data between network equipment (150) and collectors (160) using a push method. When a collector (160) sends a subscription request to network equipment (150), the network equipment (150) actively pushes performance management data to the collector (160) continuously. This method enables real-time data transmission at intervals of 1 second or less, allowing immediate monitoring and analysis of network status.

In particular, the streaming telemetry (140) method can efficiently provide real-time performance data required by applications such as artificial intelligence technology and network digital twins. By streaming data directly from network equipment (150), immediate detection and response to network status changes become possible, significantly improving network stability and performance.

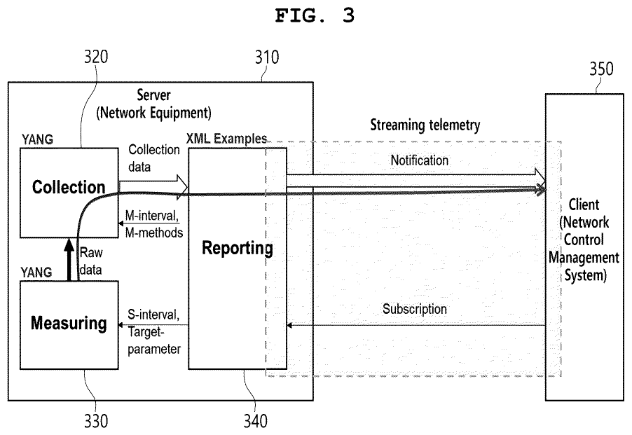

FIG. 2 is a diagram showing the overall configuration of a streaming telemetry system according to an embodiment of the present disclosure.

Referring to FIG. 2, the overall configuration is divided into a client layer and a network equipment layer. The client layer includes various applications such as network digital twin/artificial intelligence applications (210), network management (220), security management (230), and cloud services (240). The network equipment layer has multiple network equipment units (250, 260, 270, 280) distributed.

Each client (210, 220, 230, 240) sends subscription requests to corresponding network equipment units (250, 260, 270, 280) to obtain necessary performance management data. Subscription requests include desired performance parameters, measurement methods, time intervals, filtering conditions, etc. For example, a network digital twin/artificial intelligence application (210) can request real-time performance data from all network equipment for network status prediction.

Network equipment units (250, 260, 270, 280) measure performance management data according to each subscription request and stream it to corresponding clients in real time through notification methods. Each network equipment can simultaneously process subscription requests from multiple clients and support different performance parameters and transmission periods for each client.

Network management (220) mainly subscribes to performance data related to overall network operational status and fault information, while security management (230) requests traffic patterns and abnormal behavior-related data for security threat detection. Cloud services (240) monitor performance indicators such as bandwidth utilization, latency, and packet loss rates in real time to ensure service quality.

Through such many-to-many subscription relationships, each application can efficiently collect performance data optimized for its purpose, and network equipment can simultaneously satisfy multiple clients' requirements without redundant data processing.

FIG. 3 is a diagram showing the YANG data model structure inside a server and data flow with clients according to an embodiment of the present disclosure.

Referring to FIG. 3, the internal structure of the server's YANG data model and data flow with clients are shown in detail.

### Performance Parameter Selection and Measurement Method Sharing Using YANG Data Model

The server (310) and client (350) first share a YANG data model. Through the shared YANG data model, the client (350) can verify in advance the performance parameters and performance measurement methods that the server (310), which is network equipment, can provide. This allows the client (350) to understand performance parameters such as Errored Seconds (ES), Severely Errored Seconds (SES), Background Block Errors (BBE) supported by the server (310) and measurement methods such as count measurement, snapshot measurement, and tidemark measurement.

Subsequently, the client (350), which is a network control management system, selects performance parameters requiring measurement and requests subscription from the server (310). Upon receiving the subscription request, the server (310), which is network equipment, continuously delivers measurement results of requested performance parameters to the client (350) until the subscription is cancelled.

### Network Equipment Performance Measurement and Reporting Method (Performance Data Streaming)

The server (310) internal structure consists of a measurement unit (330), collection unit (320), and reporting unit (340) for performance data processing.

The measurement unit (330) performs switching functions to deliver data received from external equipment to destinations. When the client (350) requests subscription, the measurement unit (330) measures performance parameters requested for subscription. For example, it can measure error occurrence and delay levels of delivered data. When measuring error occurrence time, it measures error occurrence at 1-second intervals (sampling-interval) and delivers results to the collection unit (320).

The collection unit (320) collects measured values during measurement intervals, for example, 15 minutes or 24 hours. Based on this collected raw data, the collection unit (320) measures or calculates count, snapshot, and tidemark values. Counts represent cumulative occurrence counts during the period, snapshots represent instantaneous values at specific uniform times, and tidemarks represent maximum and minimum values during the period. This processed performance data is delivered to the reporting unit (340).

The reporting unit (340) delivers specified performance parameter values in streaming manner according to subscription requests received from the client (350). The reporting unit (340) can simultaneously process different subscription conditions for each client and pushes performance data in real-time notification methods according to specific parameters and measurement methods requested by each client.

Through this systematic data processing, the client (350) can monitor network status in real time and receive immediate and accurate performance data necessary for artificial intelligence-based analysis or network digital twin applications. In particular, interoperability between clients and servers is ensured through prior sharing of YANG data models, enabling various performance measurements in standardized ways.

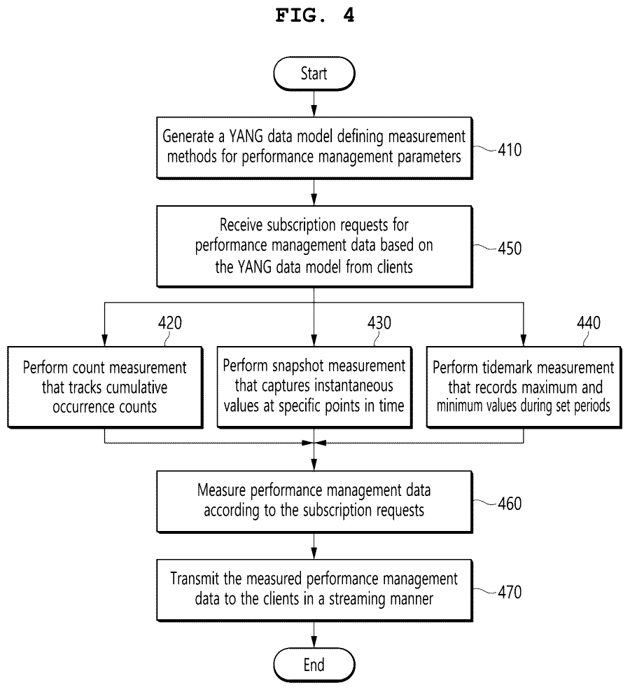

FIG. 4 shows a flowchart illustrating an operating method of a server according to an embodiment of the present disclosure.

Referring to FIG. 4, a flowchart showing the operating method of the server according to an embodiment of the present disclosure is illustrated.

In step (410), the server generates a YANG data model defining measurement methods for performance management parameters. The generated YANG data model includes the following structure:

TABLE 1

```
module: ietf-pm-streaming
  +--rw pm-periodic-measurement
    +--rw maintenance-15min
    +--rw maintenance-24hr
    +--rw qos-24hr
  notifications:
    +---n threshold-events
      +--ro periodic-threshold-events
      +--ro non-periodic-threshold-events
```

The YANG data model defines different containers for 15-minute interval maintenance monitoring, 24-hour interval maintenance monitoring, and 24-hour interval QoS monitoring. Each container includes performance parameters such as Errored Seconds (ES), Severely Errored Seconds (SES), Background Block Errors (BBE), Background Block Count (BBC), Unavailable Seconds (UAS), Pointer Justification Events (PJE), and Severely Errored Period (SEP).

In the server operating method of the present disclosure, after generating the YANG data model, subscription requests from clients are first received, and then measurements are efficiently performed only for subscribed parameters. Additionally, three measurement methods (count, snapshot, tidemark) are processed in parallel rather than sequentially to improve measurement efficiency.

In step (450), the server receives subscription requests for performance management data based on the generated YANG data model from clients. Protocols used in subscription requests are mainly NETCONF and RESTCONF, with selection criteria as follows. NETCONF is suitable when transaction-based stable configuration management is needed, while RESTCONF is suitable when lightweight RESTful API-based interfaces are needed. XML and JSON are supported as encoding methods, with XML mainly used in environments requiring strict schema validation and JSON mainly used when integration with web-based applications is needed. Additionally, the YANG data model of the present disclosure is designed considering compatibility with gNMI (gRPC Network Management Interface) and can support subscriptions through gRPC protocol when necessary.

Subscription requests can be received as NETCONF messages in the following form:

```
TABLE 2
<rpc message-id=“101” xmlns=“urn:ietf:params:xml:ns:netconf:base:1.0”>
  <establish-subscription xmlns=“urn:ietf:params:xml:ns:yang:ietf-yang-
push:1.0”>
    <filter type=“subtree”>
      <pm-periodic-measurement xmlns=“urn:ietf:params:xml:ns:yang:ietf-pm-
streaming”>
        <maintenance-15min>
          <pm-parameter>
            <parameter-name>ses</parameter-name>
            <count-measurement>
              <count-value/>
              <count-unit/>
            </count-measurement>
          </pm-parameter>
        </maintenance-15min>
      </pm-periodic-measurement>
    </filter>
    <period>900</period>
    <encoding>encode-xml</encoding>
  </establish-subscription>
</rpc>
```

This subscription request is an example requesting count values and units for Severely Errored Seconds (SES) parameters at 15-minute intervals.

In step (420), the server performs count measurement tracking cumulative occurrence counts according to received subscription requests. This step can be processed in parallel with steps (430) and (440). Count measurement is a method for periodically tracking total occurrence counts of specific network events or activities. For example, for Errored Seconds (ES) parameters, total error second counts occurring during 15 minutes or 24 hours are accumulated and counted. Count measurement can be performed using at least one of transient condition method and standing condition method. In the transient condition method, each measurement period is processed individually to immediately generate Threshold Reports (TR) when reaching or exceeding thresholds. In the standing condition method, standing conditions occur when reaching thresholds and TRs are generated, with Reset Threshold Reports (RTR) generated at period end when current values are below reset thresholds.

Specific differences between transient condition and standing condition methods are as follows. The transient condition method processes each 15-minute or 24-hour measurement period independently, generating threshold reports immediately when reaching or exceeding thresholds within that period. In contrast, the standing condition method is an option applied only to 15-minute periods, where standing conditions occur when reaching thresholds and threshold reports are generated, with reset threshold reports generated at period end when current values are below reset thresholds in states without unavailable time. Overflow conditions occur when measured values reach or exceed high thresholds, while underflow conditions occur when measured values fall below low thresholds. These conditions apply to count, snapshot, and tidemark measurements, generating High Out-of-Range Reports (High-ORR) or Low Out-of-Range Reports (Low-ORR) respectively.

In step (430), the server performs snapshot measurement capturing instantaneous values at specific points in time according to received subscription requests. This step can be processed in parallel with steps (420) and (440). Snapshot measurement is a method for capturing instantaneous values of performance parameters at predetermined uniform times within each time interval. For example, when set to 15-minute intervals, measurements are performed at exactly the same times every 15 minutes (e.g., 0, 15, 30, 45 minutes of every hour). Snapshot data enables immediate understanding of current network status, and by taking snapshots simultaneously across all network elements, correlation analysis of the entire network becomes possible. Snapshot measurement can also detect out-of-range events by setting high-oor-threshold and low-oor-threshold.

Synchronization mechanisms for uniform time in snapshot measurement are important for ensuring consistency across the entire network. All network elements use the same time reference (e.g., UTC) to perform measurements at exactly the same points in time. For example, when set to 15-minute intervals, all equipment simultaneously takes snapshots at exactly the hour, 15 minutes, 30 minutes, and 45 minutes of every hour. Through this synchronization, correlation analysis between data collected from different points in the network can be accurately performed.

In step (440), the server performs tidemark measurement recording maximum and minimum values during set periods according to received subscription requests. This step can be processed in parallel with steps (420) and (430). Tidemark measurement is a method for recording maximum values (high tidemark) and minimum values (low tidemark) reached by performance parameters during specified observation periods. These extreme values provide insights into performance variation ranges, highlighting best and worst conditions occurring within monitoring periods. For example, even when average error rates are within acceptable ranges, intermittent error surges can be discovered through high tidemarks, and periods of severely degraded signal quality or throughput can be exposed through low tidemarks. Tidemark measurement can also determine overflow and underflow conditions using high and low thresholds and generate Out of Range Reports (ORR).

In step (460), the server collects performance management data measured in parallel in steps (420), (430), and (440) and formats it according to structures defined in the YANG data model. The server applies corresponding measurement methods (count, snapshot, tidemark) to collect data for specific performance parameters requested by clients. Measured data is formatted according to structures defined in the YANG data model and includes information such as timestamps, measured values, and units.

In step (470), the server transmits measured performance management data to clients in streaming manner. Transmitted data can be delivered as NETCONF notifications in the following form:

TABLE 3

```
<notification xmlns=“urn:ietf:params:xml:ns:netconf:notification:1.0”>
  <eventTime>2024-10-10T15:15:00Z</eventTime>
  <pm-periodic-measurement xmlns=“urn:ietf.params:xml:ns:yang:ietf-pm-
streaming”>
    <maintenance-15min>
      <pm-parameter>
        <parameter-name>ses</parameter-name>
        <count-measurement>
          <count-value>5</count-value>
          <count-unit>seconds</count-unit>
        </count-measurement>
      </pm-parameter>
    </maintenance-15min>
  </pm-periodic-measurement>
</notification>
```

Additionally, the server can send separate event notifications when threshold events occur. Periodic threshold events include count transient events, count standing events, snapshot events, and tidemark events, while non-periodic threshold events include Begin Unavailable Time (BUT) events, End Unavailable Time (EUT) events, and Consecutive Severely Errored Seconds (CSES) events.

Through these step-by-step processes, the server can provide performance management data in real time according to various client requirements, enabling immediate monitoring and analysis of network status.

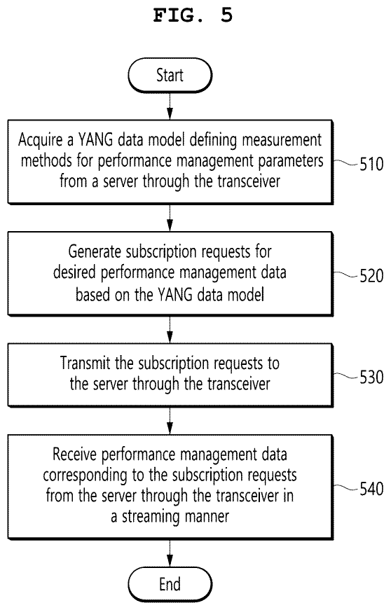

Referring to FIG. 5, a flowchart showing the operating method of the client according to an embodiment of the present disclosure is illustrated.

In step (510), the client acquires a YANG data model defining measurement methods for performance management parameters from the server through the transceiver. Through the YANG data model provided by the server, the client can understand information as such available performance parameters, measurement methods, time intervals. The acquired YANG data model includes the following main structures:
⊏ pm-periodic-measurement container: top-level container for periodic performance measurement
⊏ maintenance-15 min: parameter group for 15-minute interval maintenance monitoring
┌ maintenance-24 hr: parameter group for 24-hour interval maintenance monitoring
⊏ qos-24 hr: parameter group for 24-hour interval QoS monitoring

Each parameter group defines performance parameters such as Errored Seconds (ES), Severely Errored Seconds (SES), Background Block Errors (BBE), Background Block Count (BBC), and Unavailable Seconds (UAS), along with applicable measurement methods (count, snapshot, tidemark) for those parameters.

In step (520), the client generates subscription requests for desired performance management data based on the YANG data model. When generating subscription requests, the client determines the following elements:
└ Measurement methods: selection among count measurement, snapshot measurement, tidemark measurement
   | Performance parameters: selection of necessary parameters among ES, SES, BBE, BBC, UAS, PJE, SEP
   | Time intervals: setting 15-minute or 24-hour intervals
┌ Monitoring purpose: distinction between maintenance monitoring or QoS monitoring
⊏ Filtering conditions: setting data filtering according to specific thresholds or conditions

For example, for periodic subscriptions, the following NETCONF request can be generated:

```
<rpc message-id=“101” xmlns=“urn:ietf:params:xml:ns:netconf:base:1.0”>
  <establish-subscription xmlns=“urn:ietf:params:xml:ns:yang:ietf-yang-
push:1.0”>
    <filter type=“subtree”>
      <pm-periodic-measurement xmlns=“urn:ietf:params:xml:ns:yang:ietf-pm-
streaming”>
        <maintenance-15min>
          <pm-parameter>
            <parameter-name>ses</parameter-name>
            <count-measurement>
              <count-value/>
              <count-unit/>
            </count-measurement>
          </pm-parameter>
        </maintenance-15min>
      </pm-periodic-measurement>
    </filter>
    <period>900</period>
    <encoding>encode-xml</encoding>
  </establish-subscription>
</rpc>
```

For event-based subscriptions, the following can be generated including threshold settings:

```
<rpc message-id=“104” xmlns=“urn:ietf:params:xml:ns:netconf:base:1.0”>
  <establish-subscription xmlns=“urn:ietf:params:xml:ns:yang:ietf-subscribed-
notifications”>
    <stream>ietf-push</stream>
    <encoding>encode-xml</encoding>
    <periodic>
      <period>900</period>
    </periodic>
    <filter type=“subtree”>
      <pm-periodic-measurement xmlns=“urn:ietf:params:xml:ns:yang:ietf-pm-
streaming”>
        <maintenance-15min>
          <pm-parameter>
            <parameter-name>ses</parameter-name>
            <snapshot-measurement>
              <uniform-time>120</uniform-time>
              <high-oor-threshold>8</high-oor-threshold>
            </snapshot-measurement>
          </pm-parameter>
        </maintenance-15min>
      </pm-periodic-measurement>
    </filter>
  </establish-subscription>
</rpc>
```

In step (530), the client transmits subscription requests to the server through the transceiver. Transmitted subscription requests are delivered to the server through NETCONF or RESTCONF protocols. Subscription requests include specific specifications for performance data desired by clients, and servers set up dedicated streaming sessions for those clients based on this information. Clients can request multiple subscriptions simultaneously for one server, with each subscription managed independently.

In step (540), the client receives performance management data corresponding to subscription requests from the server through the transceiver in streaming manner. Received data is delivered as NETCONF notifications in the following form:

Periodic data notification example:

```
<notification xmlns=“urn:ietf:params:xml:ns:netconf:notification:1.0”>
  <eventTime>2024-10-10T15:15:00Z</eventTime>
  <pm-periodic-measurement xmlns=“urn:ietf:params:xml:ns:yang:ietf-pm-
streaming”>
    <maintenance-15min>
      <pm-parameter>
        <parameter-name>ses</parameter-name>
        <count-measurement>
          <count-value>5</count-value>
          <count-unit>seconds</count-unit>
        </count-measurement>
      </pm-parameter>
    </maintenance-15min>
  </pm-periodic-measurement>
</notification>
```

Event-based notification example:

```
<notification xmlns=“urn:ietf:params:xml:ns:netconf:notification:1.0”>
  <eventTime>2024-10-10T15:15:00Z</eventTime>
  <pm-periodic-measurement xmlns=“urn:ietf:params:xml:ns:yang:ietf-pm-
streaming”>
    <maintenance-15min>
      <pm-parameter>
        <parameter-name>ses</parameter-name>
        <snapshot-measurement>
          <snapshot-event>
            <event-type>High-OOR-event</event-type>
            <event-occurred>true</event-occurred>
            <event-time>2024-10-10T15:14:00Z</event-time>
          </snapshot-event>
          <snapshot-value>10</snapshot-value>
          <high-oor-threshold>8</high-oor-threshold>
        </snapshot-measurement>
      </pm-parameter>
    </maintenance-15min>
  </pm-periodic-measurement>
</notification>
```

For non-periodic events, event information such as BUT (Begin Unavailable Time), EUT (End Unavailable Time), and CSES (Consecutive Severely Errored Seconds) is included:

```
<rpc message-id=“105” xmlns=“urn:ietf:params:xml:ns:netconf:base:1.0”>
  <establish-subscription xmlns=“urn:ietf:params:xml:ns:yang:ietf-subscribed-
notifications”>
    <stream>ietf-push</stream>
    <encoding>encode-xml</encoding>
    <filter type=“subtree”>
      <pm-periodic-measurement xmlns=“urn:ietf:params:xml:ns:yang:ietf-pm-
streaming”>
        <BUT-event>
          <event-occurred/>
          <event-time/>
        </BUT-event>
      </pm-periodic-measurement>
    </filter>
  </establish-subscription>
</rpc>
```

Clients can utilize received performance management data according to purposes such as network digital twins, artificial intelligence applications, network management, or security management. Additionally, clients can dynamically modify subscription parameters or pause and resume subscriptions as needed, and can collect performance data simultaneously from multiple servers to perform integrated network monitoring when necessary.

### Specific Structure of YANG Data Model According to the Present Disclosure

The YANG data model for performance management streaming of the present disclosure has the following tree structure:

module: ietf-pm-streaming

| +--rw pm-periodic-measurement | | | |
|---|---|---|---|
| +--rw maintenance-15min | | | |
| \| | +--rw pm-parameter* [parameter-name] | | |
| \| | +--rw parameter-name maintenance-parameter | | |
| \| | +--rw count-measurement | | |
| \| | \| | +--ro count-value? uint32 | |
| \| | \| | +--ro count-unit? parameter-unit | |
| \| | \| | +--rw transient-condition-config | |
| \| | \| | \| | +--rw high-oor-threshold? uint32 |
| \| | \| | \| | +--rw low-oor-threshold? uint32 |
| \| | \| | +--rw standing-condition-config | |
| \| | \| | +--rw standing-threshold? uint32 | |
| \| | \| | +--rw standing-reset-threshold? uint32 | |
| \| | +--rw snapshot-measurement | | |
| \| | \| | +--rw uniform-time? uint32 | |
| \| | \| | +--ro snapshot-value? uint32 | |
| \| | \| | +--ro snapshot-unit? parameter-unit | |
| \| | \| | +--rw high-oor-threshold? uint32 | |
| \| | \| | +--rw low-oor-threshold? uint32 | |
| \| | +--rw tidemark-maintenance | | |
| \| | +--ro high-tide-value? uint32 | | |
| \| | +--ro high-tide-unit? parameter-unit | | |
| \| | +--ro low-tide-value? uint32 | | |
| \| | +--ro low-tide-unit? parameter-unit | | |
| \| | +--rw high-oor-threshold? uint32 | | |
| \| | +--rw low-oor-threshold? uint32 | | |
| +--rw maintenance-24hr | | | |
| \| | +--rw pm-parameter* [parameter-name] | | |
| \| | +--rw parameter-name maintenance-parameter-extended | | |
| \| | +--rw count-measurement | | |
| \| | \| | +--ro count-value? uint32 | |
| \| | \| | +--ro count-unit? parameter-unit | |
| \| | \| | +--rw transient-condition-config | |
| \| | \| | +--rw high-oor-threshold? uint32 | |
| \| | \| | +--rw low-oor-threshold? uint32 | |
| \| | +--rw snapshot-measurement | | |
| \| | \| | +--rw uniform-time? uint32 | |
| \| | \| | +--ro snapshot-value? uint32 | |
| \| | \| | +--ro snapshot-unit? parameter-unit | |
| \| | \| | +--rw high-oor-threshold? uint32 | |
| \| | \| | +--rw low-oor-threshold? uint32 | |
| \| | +--rw tidemark-maintenance | | |
| \| | +--ro high-tide-value? uint32 | | |
| \| | +--ro high-tide-unit? parameter-unit | | |
| \| | +--ro low-tide-value? uint32 | | |
| \| | +--ro low-tide-unit? parameter-unit | | |
| \| | +--rw high-oor-threshold? uint32 | | |
| \| | +--rw low-oor-threshold? uint32 | | |
| +--rw qos-24hr | | | |
| +--rw pm-parameter* [parameter-name] | | | |
| +--rw parameter-name qos-parameters | | | |
| +--rw count-measurement | | | |
| +--ro count-value? uint32 | | | |
| +--ro count-unit? parameter-unit | | | |
| +--rw transient-condition-config | | | |
| +--rw high-oor-threshold? uint32 | | | |
| +--rw low-oor-threshold? uint32 | | | |
| notifications: | | | |
| +---n threshold-events | | | |
| +--ro periodic-threshold-events | | | |
| \| | +--ro maintenance-15min | | |
| \| | \| | +--ro pm-parameter* [parameter-name] | |
| \| | \| | +--ro parameter-name maintenance-parameter | |
| \| | \| | +--ro count-transient-event | |
| \| | \| | \| | +--ro event-type? enumeration |
| \| | \| | \| | +--ro event-occurred? boolean |
| \| | \| | \| | +--ro event-time? yang:date-and-time |
| \| | \| | +--ro count-standing-event | |
| \| | \| | \| | +--ro event-type? enumeration |
| \| | \| | \| | +--ro event-occurred? boolean |
| \| | \| | \| | +--ro event-time? yang:date-and-time |
| \| | \| | +--ro snapshot-event | |
| \| | \| | \| | +--ro event-type? enumeration |
| \| | \| | \| | +--ro event-occurred? boolean |
| \| | \| | \| | +--ro event-time? yang:date-and-time |
| \| | \| | +--ro tidemark-event | |
| \| | \| | +--ro event-type? enumeration | |
| \| | \| | +--ro event-occurred? boolean | |
| \| | \| | +--ro event-time? yang:date-and-time | |
| \| | +--ro maintenance-24hr | | |
| \| | \| | +--ro pm-parameter* [parameter-name] | |
| \| | \| | +--ro parameter-name maintenance-parameter | |
| \| | \| | +--ro count-transient-event | |
| \| | \| | \| | +--ro event-type? enumeration |
| \| | \| | \| | +--ro event-occurred? boolean |
| \| | \| | \| | +--ro event-time? yang:date-and-time |
| \| | \| | +--ro snapshot-event | |
| \| | \| | \| | +--ro event-type? enumeration |
| \| | \| | \| | +--ro event-occurred? boolean |
| \| | \| | \| | +--ro event-time? yang:date-and-time |

| | | |
|---|---|---|
| \| | \| | +--ro tidemark-event |
| \| | \| | +--ro event-type? enumeration |
| \| | \| | +--ro event-occurred? boolean |
| \| | \| | +--ro event-time? yang:date-and-time |

| \| | +--ro qos-24hr |
|---|---|
| \| | +--ro pm-parameter* [parameter-name] |
| \| | +--ro parameter-name qos-parameters |
| \| | +--ro count-transient-event |
| \| | +--ro event-type? enumeration |
| \| | +--ro event-occurred? boolean |
| \| | +--ro event-time? yang:date-and-time |
| +--ro non-periodic-threshold-events | |
| +--ro BUT-event | |
| \| | +--ro event-occurred? boolean |
| \| | +--ro event-time? yang:date-and-time |
| +--ro EUT-event | |
| \| | +--ro event-occurred? boolean |
| \| | +--ro event-time? yang:date-and-time |
| \| | +--ro total-unavailable-time? uint32 |

+--ro CSES-event
+--ro event-occurred? boolean
+--ro begin-time? yang:date-and-time
+--ro end-time? yang:date-and-time
+--ro duration? uint32
+--ro error-count? uint32

The YANG data model of the present disclosure currently defines performance parameters focused on circuit networks but is designed to be extensible to additional parameters for packet networks. For example, for “Jitter” parameters, “tidemark measurement” can be applied to record maximum and minimum jitter during specific periods, enabling monitoring of communication quality variation ranges. Additionally, “Packet Loss” can track cumulative loss counts through “count measurement.” In this way, the measurement methodology of the present disclosure can be effectively applied to core parameters of packet networks. When extending, modularized structures are provided so that new measurement methods suited to packet network characteristics can be added while utilizing existing measurement methods (count, snapshot, tidemark).

### Detailed Definition of YANG Data Model According to the Present Disclosure

The complete YANG module for performance management streaming of the present disclosure is defined as follows:

### Subscription Examples According to the Present Disclosure

In performance management streaming of the present disclosure, clients can subscribe to performance data in various ways. The following are specific examples by major subscription types.

### Periodic Subscription Example

The following is an example of a subscription request to periodically receive count values and units of Severely Errored Seconds (SES) parameters for 15-minute interval maintenance monitoring:

```
<rpc message-id=“101”
  xmlns=“urn:ietf:params:xml:ns:netconf:base:1.0”>
  <establish-subscription
  xmlns=“urn:ietf:params:xml:ns:yang:ietf-yang-push:1.0”>
<filter type=“subtree”>
  <pm-periodic-measurement xmlns=“urn:ietf:params:
xml:ns:yang:ietf-pm-streaming”>
  <maintenance-15min>
  <pm-parameter>
  <parameter-name>ses</parameter-name>
  <count-measurement>
  <count-value/>
  <count-unit/>
  </count-measurement>
  </pm-parameter>
  </maintenance-15min>
  </pm-periodic-measurement>
  </filter>
<period>900</period>
<encoding>encode-xml</encoding>
  </establish-subscription>
</rpc>
```

In this request, the period value of 900 seconds (15 minutes) represents the cycle at which the client wants to receive performance data.

### Periodic Event Subscription Example

The following is an example of subscribing to high threshold exceeding events in snapshot measurement of Severely Errored Seconds (SES) parameters. Snapshots are performed every 2 minutes with high threshold set to 8 seconds:

```
<rpc message-id=“104”
  xmlns=“urn:ietf:params:xml:ns:netconf:base:1.0”>
  <establish-subscription
  xmlns=“urn:ietf:params:xml:ns:yang:ietf-subscribed-notifications”>
  <stream>ietf-push</stream>
  <encoding>encode-xml</encoding>
  <periodic>
  <period>900</period> <!-- 15 minutes in seconds -->
  </periodic>
  <filter type=“subtree”>
  <pm-periodic-measurement
xmlns=“urn:ietf:params:xml:ns:yang:ietf-pm-streaming”>
  <maintenance-15min>
  <pm-parameter>
  <parameter-name>ses</parameter-name>
  <snapshot-measurement>
  <uniform-time>120</uniform-time> <!-- 2 minutes in
seconds -->
  <high-oor-threshold>8</high-oor-threshold> <!-- High
OOR threshold set to 8 seconds -->
  <snapshot-event>
  <oor-threshold-type>
  <event-type>High-OOR-event</event-type>
  </oor-threshold-type>
  </snapshot-event>
  </snapshot-measurement>
  </pm-parameter>
  </maintenance-15min>
  </pm-periodic-measurement>
  </filter>
  </establish-subscription>
</rpc>
```

### Periodic Event Notification Example

An example of server notification response to the above event subscription is as follows:

```
<notification
xmlns=“urn:ietf:params:xml:ns:netconf:notification:1.0”>
  <eventTime>2024-10-10T15:15:00Z</eventTime>
  <pm-periodic-measurement xmlns=“urn:ietf:params:xml:ns:yang:ietf-
pm-streaming”>
  <maintenance-15min>
  <pm-parameter>
  <parameter-name>ses</parameter-name>
  <snapshot-measurement>
  <snapshot-event>
  <oor-threshold-type>
  <event-type>High-OOR-event</event-type>
  </oor-threshold-type>
  <event-occurred>true</event-occurred>
  <event-time>2024-10-10T15:14:00Z</event-time>
  </snapshot-event>
  <snapshot-value>10</snapshot-value>
  <high-oor-threshold>8</high-oor-threshold>
  </snapshot-measurement>
  </pm-parameter>
  </maintenance-15min>
  </pm-periodic-measurement>
</notification>
```

This notification indicates that a high threshold event occurred because the snapshot-value of 10 seconds exceeded the set high-oor-threshold of 8 seconds.

### Non-Periodic Event Subscription Example

The following is an example of subscribing to Begin Unavailable Time (BUT) events:

```
<rpc message-id=“105”
  xmlns=“urn:ietf:params:xml:ns:netconf:base:1.0”>
  <establish-subscription
  xmlns=“urn:ietf:params:xml:ns:yang:ietf-subscribed-notifications”>
  <stream>ietf-push</stream>
  <encoding>encode-xml</encoding>
  <filter type=“subtree”>
  <pm-periodic-measurement
xmlns=“urn:ietf:params:xml:ns:yang:ietf-pm-streaming”>
  <BUT-event>
  <event-occurred/>
  <event-time/>
  </BUT-event>
  </pm-periodic-measurement>
  </filter>
  </establish-subscription>
</rpc>
```

Non-periodic events are immediately notified when specific network status changes occur, regardless of measurement methods or cycles. BUT events indicate when network elements or connections become unavailable, while corresponding EUT (End Unavailable Time) events notify when unavailable states end.

### Consecutive Severely Errored Seconds (CSES) Event Subscription

Another non-periodic event, CSES event subscription example is as follows:

```
<rpc message-id=“106”
  xmlns=“urn:ietf:params:xml:ns:netconf:base:1.0”>
  <establish-subscription
  xmlns=“urn:ietf:params:xml:ns:yang:ietf-subscribed-notifications”>
  <stream>ietf-push</stream>
  <encoding>encode-xml</encoding>
  <filter type=“subtree”>
  <pm-periodic-measurement
xmlns=“urn:ietf:params:xml:ns:yang:ietf-pm-streaming”>
  <CSES-event>
  <event-occurred/>
  <begin-time/>
  <end-time/>
  <duration/>
  <error-count/>
  </CSES-event>
  </pm-periodic-measurement>
  </filter>
  </establish-subscription>
</rpc>
```

CSES events provide information about consecutively occurring severe errors and include detailed information such as start time, end time, duration, and error count.

Through these various subscription methods, clients can efficiently collect performance management data suited to their requirements, enabling real-time monitoring and analysis of network status.

### Multiple Client Simultaneous Subscription Scenario

In the present disclosure, one server can simultaneously process subscriptions from multiple clients. For example, network management clients can subscribe to error parameters for fault detection while AI applications simultaneously subscribe to throughput parameters for performance prediction. Servers maintain independent subscription sessions for each client and individually manage subscription conditions and transmission periods.

### Subscription Failure and Recovery Mechanisms

When subscription requests fail, servers notify clients of failure causes along with error codes. Major failure causes include requests for unsupported parameters, resource shortages due to excessive subscription requests, and network connection problems. After receiving failure responses, clients can retry with modified subscription conditions or change subscriptions to alternative parameters.

### Dynamic Subscription Modification

Even when subscriptions are active, clients can dynamically modify subscription conditions. For example, transmission periods can be shortened from 15 minutes to 5 minutes, new performance parameters can be added, or thresholds can be changed. Modification requests are applied in real time without interrupting existing subscriptions, and data streaming continues according to new conditions once modifications are completed.

### Time Interval Settings

15-minute and 24-hour intervals are standard intervals used in traditional network performance management. However, with the emergence of artificial intelligence technology and network digital twins, shorter sampling intervals are becoming necessary. These technologies require real-time or near-real-time performance data to operate optimally. In AI-based network analysis, data can be collected at intervals of 1 second or less to respond more quickly to network changes and improve overall network reliability and performance. The YANG data model of the present disclosure supports flexible time interval settings to accommodate these requirements.

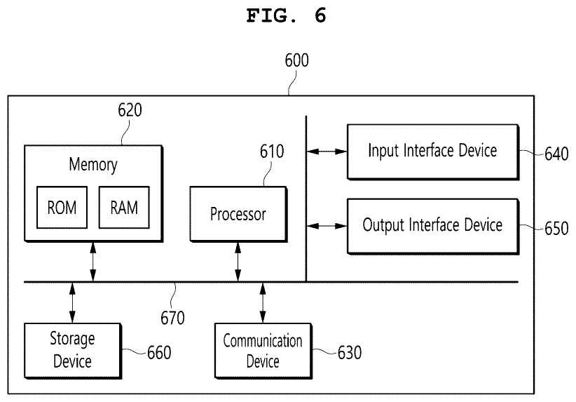

FIG. 6 shows a device configuration diagram according to an embodiment of the present disclosure.

Referring to FIG. 6, a device configuration according to an embodiment of the present disclosure is shown. The device (600) may include at least one processor (610), memory (620), and a transceiver (630) connected to a network to perform communication. Additionally, the device (600) may further include an input interface device (640), output interface device (650), storage device (660), etc. Each component included in the device (600) may be connected by a bus (670) to perform communication with each other.

The device (600) represents common hardware configuration applicable to both server devices and client devices according to the present disclosure. When operating as a server device, the device (600) performs functions of generating YANG data models and measuring and streaming performance management data. When operating as a client device, the device (600) performs functions of acquiring YANG data models from servers and transmitting subscription requests to receive performance management data.

However, each component included in the device (600) may be connected through individual interfaces or individual buses centered on the processor (610) rather than the common bus (670). For example, the processor (610) may be connected to at least one of memory (620), transceiver (630), input interface device (640), output interface device (650), and storage device (660) through dedicated interfaces.

The processor (610) may execute program commands stored in at least one of memory (620) and storage device (660). The processor (610) may refer to a central processing unit (CPU), graphics processing unit (GPU), or dedicated processor for performing methods according to embodiments of the present disclosure.

For server devices, the processor (610) executes functions of generating YANG data models defining measurement methods for performance management parameters, performing count measurement, snapshot measurement, and tidemark measurement, processing subscription requests from clients, and transmitting measured performance management data in streaming manner. For client devices, the processor (610) executes functions of acquiring YANG data models from servers, generating and transmitting subscription requests, and processing received performance management data.

The communication device (630) is a component performing core roles in the present disclosure, responsible for performance management data streaming between servers and clients. The communication device (630) may include or comprise a transceiver capable of both transmitting and receiving data. The communication device (630) supports protocols such as NETCONF and RESTCONF and can transmit and receive subscription requests and notification messages in XML format.

Memory (620) and storage device (660) may each consist of at least one of volatile storage media and non-volatile storage media. For example, memory (620) may consist of at least one of read only memory (ROM) and random access memory (RAM). Memory (620) may store YANG data models, performance management parameter definitions, and measured performance data, while storage device (660) may store performance data or configuration information requiring long-term retention.

Input interface device (640) and output interface device (650) provide user interfaces allowing administrators or operators to configure and monitor device (600). This enables YANG data model configuration, subscription condition changes, and performance data inquiries.

Methods according to embodiments described in claims or specifications of the present disclosure may be implemented in the form of hardware, software, or combinations of hardware and software.

When implementing in software, computer-readable storage media storing one or more programs (software modules) may be provided. One or more programs stored in computer-readable storage media are configured for execution by one or more processors within electronic devices. One or more programs include instructions that cause electronic devices to execute methods according to embodiments described in claims or specifications of the present disclosure.

Such programs (software modules, software) may be stored in random access memory, non-volatile memory including flash memory, read only memory (ROM), electrically erasable programmable read only memory (EEPROM), magnetic disc storage devices, compact disc-ROM (CD-ROM), digital versatile discs (DVDs) or other forms of optical storage devices, or magnetic cassettes. Alternatively, they may be stored in memory consisting of combinations of some or all of these. Additionally, each configuration memory may be included in multiple units.

Furthermore, programs may be stored in attachable storage devices accessible through communication networks such as Internet, Intranet, local area network (LAN), wide area network (WAN), or storage area network (SAN), or combinations thereof. Such storage devices may connect to devices performing embodiments of the present disclosure through external ports. Additionally, separate storage devices on communication networks may connect to devices performing embodiments of the present disclosure.

In specific embodiments of the present disclosure described above, components included in the disclosure are expressed in singular or plural forms according to presented specific embodiments. However, singular or plural expressions are selected appropriately for situations presented for convenience of explanation, and the present disclosure is not limited to singular or plural components. Components expressed in plural may be configured in singular, and components expressed in singular may be configured in plural.

Meanwhile, while the detailed description of the present disclosure describes embodiments, specific various modifications are possible within the scope of the present disclosure. Therefore, the scope of the present disclosure should not be limited to described embodiments but should be determined by the scope of claims described below as well as equivalents to this scope of claims.

What is claimed is:

1. A server device for YANG data modeling of performance management streaming in a communication system, comprising:
a transceiver; and a processor operatively connected to the transceiver,
wherein the processor is configured to: generate a YANG data model defining measurement methods for performance management parameters, perform count measurement that tracks cumulative occurrence counts, perform snapshot measurement that captures instantaneous values at specific points in time, perform tidemark measurement that records maximum and minimum values during set periods, receive subscription requests for performance management data based on the YANG data model from clients, measure performance management data according to the subscription requests, and transmit the measured performance management data to the clients in a streaming manner.

2. The device of claim 1, wherein the performance management parameters include maintenance parameters for network maintenance and QoS parameters for service quality monitoring.

3. The device of claim 1, wherein the processor is configured to define different parameter types for 15-minute interval maintenance monitoring, 24-hour interval maintenance monitoring, and 24-hour interval QoS monitoring in the YANG data model.

4. The device of claim 1, wherein the processor is configured to generate periodic threshold events and non-periodic threshold events when measured values reach or exceed preset thresholds and transmit them to the clients.

5. The device of claim 1, wherein the snapshot measurement is performed at predetermined uniform times within fixed intervals, and the count measurement is performed using at least one of a transient condition method or a standing condition method.

6. An operating method of a server for YANG data modeling of performance management streaming in a communication system, comprising:
generating a YANG data model defining measurement methods for performance management parameters; performing count measurement that tracks cumulative occurrence counts; performing snapshot measurement that captures instantaneous values at specific points in time; performing tidemark measurement that records maximum and minimum values during set periods; receiving subscription requests for performance management data based on the YANG data model from clients; measuring performance management data according to the subscription requests; and the measured transmitting performance management data to the clients in a streaming manner.

7. The method of claim 6, wherein the performance management parameters include at least one of Errored Seconds (ES), Severely Errored Seconds (SES), Background Block Errors (BBE), Background Block Count (BBC), or Unavailable Seconds (UAS).

8. The method of claim 6, further comprising defining different parameter types for 15-minute interval maintenance monitoring, 24-hour interval maintenance monitoring, and 24-hour interval QoS monitoring in the YANG data model.

9. The method of claim 6, further comprising: generating periodic threshold events and non-periodic threshold events when measured values reach or exceed preset thresholds; and transmitting the generated threshold events to the clients.

10. The method of claim 6, further comprising disclosing the YANG data model to the clients, wherein the snapshot measurement is performed at predetermined uniform times within fixed intervals, and the count measurement is performed using at least one of a transient condition method or a standing condition method.

11. A client device for YANG data modeling of performance management streaming in a communication system, comprising:
a transceiver; and a processor operatively connected to the transceiver,
wherein the processor is configured to: acquire a YANG data model defining measurement methods for performance management parameters from a server through the transceiver, generate subscription requests for desired performance management data based on the YANG data model, transmit the subscription requests to the server through the transceiver, and receive performance management data corresponding to the subscription requests from the server through the transceiver in a streaming manner.

12. The device of claim 11, wherein the processor is configured to provide the received performance management data to network digital twins or artificial intelligence applications.

13. The device of claim 11, wherein the subscription requests include at least one of measurement methods, time intervals, or filtering conditions.

14. The device of claim 11, wherein the processor is configured to receive threshold event notifications from the server and process the threshold event notifications.

15. The device of claim 11, wherein the processor is configured to modify parameters of the subscription requests or pause subscriptions.
